(19) United States
(12) Patent Application Publication
(10) Pub. No.: US 2017/0091555 A1
(43) Pub. Date: Mar. 30, 2017

(54) IDENTIFICATION SYSTEM

(71) Applicant: Khan Ali Yousafi, Westbury, NY (US)

(72) Inventor: Khan Ali Yousafi, Westbury, NY (US)

(21) Appl. No.: 15/378,822

(22) Filed: Dec. 14, 2016

Related U.S. Application Data
(62) Division of application No. 14/014,060, filed on Aug. 29, 2013.
(60) Provisional application No. 61/743,557, filed on Sep. 7, 2012.

(51) Int. Cl. G06K 9/00; H04N 5/232; H04N 5/225; B60R 21/0136; H04N 7/18; G07C 5/08; G07C 5/00; H04N 5/247; H04N 5/235

(52) U.S. Cl. CPC G06K 9/00711; H04N 5/247; H04N 5/23216; H04N 5/2256; H04N 5/2354; G06K 9/00771; G06K 9/00791; H04N 7/188; G07C 5/0866; G07C 5/008; B60R 21/0136; G06K 2009/00738; B60R 2021/0027

(57) ABSTRACT

An identification system and method of operation for identifying, recording, and alerting to an impact between a vehicle and an impacting object, such as another vehicle that impacts the vehicle. At least one sensor is positioned on front and rear bumpers of the vehicle for sensing the impact and actuating the system. At least one camera on the vehicle periphery records the impacting object. Each camera is positioned on a periphery of the vehicle and tilts up to 180 degrees. An alert portion emits an alert in response to the impact. An antenna communicates with a positioning system to identify a location of the vehicle during the impact. A communication device stores and relays information, such as vehicle identification number, license plate number, and driver's license information of the impacting object to an emergency department. A processor and a SIM card store and identify information about each vehicle.

### CROSS-REFERENCE TO RELATED APPLICATIONS

This application is a divisional of application Ser. No. 14/014,060 filed Aug. 29, 2013, which claims the benefit of application Ser. No. 61/743,557 filed Sep. 7, 2012. The contents of the prior applications are incorporated herein by reference for all purposes to the extent that such subject matter is not inconsistent herewith or limiting hereof.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to collision identification systems. More particularly, the invention relates to identifying an impacting vehicle involved in a collision.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a traffic collision occurs when a vehicle collides with another vehicle, pedestrian, animal, road debris, or other stationary obstruction, such as a tree or utility pole. Traffic collisions often result in injury, death, vehicle damage, and property damage.

Typically, a number of factors contribute to the risk of collision, including vehicle design, speed of operation, road design, road environment, driver skill and/or impairment, and driver behavior. Traffic collisions often to death and disability as well as financial costs to both society and the individuals involved.

Often, a sensor is a converter that measures a physical quantity and converts it into a signal which can be read by an observer or by an instrument. An impact sensor detects and signals a force or collision.

It is well known that a camera is an optical instrument that records images that can be stored directly, transmitted to another location, or both. These images may be still photographs or moving images such as videos or movies.

One can expect that the failure to identify the impacting vehicle in a traffic collision can lead to criminal acts of hit-and-run, insurance liabilities, and unreported accidents. These can be costly to a vehicle operator who has been involved in a collision. An impact sensor can detect a collision. A camera can record a collision.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B, and 1C illustrate various views of an exemplary vehicle with an exemplary identification system, where FIG. 1A illustrates a side view of an exemplary vehicle, FIG. 1B illustrates a rear view of an exemplary vehicle, and FIG. 1C illustrates a detailed perspective view of an exemplary vehicle, in accordance with an embodiment of the present invention;

FIG. 2 illustrates a detailed perspective view of an exemplary collision between an exemplary vehicle and an exemplary impacting object, in accordance with an embodiment of the present invention;

FIG. 3 illustrates a block diagram of an exemplary communication system communicating a collision to a remote location, in accordance with an embodiment of the present invention; and

FIG. 4 illustrates a typical computer system that, when appropriately configured or designed, can serve as an exemplary method for detection, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Peri, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections(e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing systems memories, registers or other such information, storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The present invention will now be described in detail with reference to embodiments thereof as illustrated in the accompanying drawings.

There are various types of vehicle identification systems that may be provided by preferred embodiments of the present invention. In one embodiment of the present invention, the vehicle identification system may provide a system for identifying at least one impacting object in a collision or accident. The identification system may join with a vehicle to detect a forceful collision with the impacting object, identify the impacting object, store information about the impacting object, and finally relay the information to a remote location. The impacting object may include, without limitation, at least one impacting vehicle that imparts a force on the vehicle. In this manner, a collision may be better documented and relayed to a proper authorities automatically. Those skilled in the art, in light of the present teachings, will recognize that during a collision, a vehicle operator may not be able to identify and relay information about a collision. The identification system automatically performs this task. Additionally, the identification system may help retrieve the vehicle if it is lost or stolen.

In one embodiment of the present invention, the identification system may include a plurality of components that create a synergy that helps identify the impacting object immediately during a collision. Each component may perform an interdependent function for identifying and relaying information about the collision and the impacting object. In some embodiments, the identification system may include at least one impact sensor. The at least one impacting sensor serves to actuate the identification system upon sensing a collision. The at least one impact sensor may be operable to detect an impact, vibration, and physical deformation on the vehicle from the impacting object. The at least one impact sensor may be disposed to position on a periphery of the vehicle, including, without limitation, a front bumper, a rear bumper, the sides of the vehicle, and the front and back. Each sensor comprises a 180° view.

In some embodiments, the identification system may include at least one camera for capturing an image of the impacting object prior to, during, and after a collision. The at least one camera may include, without limitation, a still photo camera, and a video camera. Each camera may position in a strategic location on the vehicle for capturing the desired image. Those skilled in the art, in light of the present teachings, will recognize that traffic collision configurations most often include, without limitation, head-on, road departure, rear-end, side collisions, and rollovers. The at least one camera should be positioned to capture these angles of collision. In some embodiments, the at least one camera may be disposed to position on a front section and a rear section of the vehicle, such as on the roof. The at least one camera may further be disposed to position on a left side section and a right side section of the vehicle, in proximity to a vehicle door. The at least one camera may be operable to provide a 180° view. The at least one camera may position flush against the vehicle, to form a flat surface. In some embodiments, the at least one camera may create a flash at the time of taking the image. The flash may be actuated by an antenna. The image generated by the at least one camera may be recorded through various means, including, without limitation, saved on a SIM card, printed, and transmitted to a remote location.

In one embodiment of the present invention, the identification system may include an alert portion that operatively joins with the at least one camera and the at least one impact sensor. The alert portion may emit an alert in response to the collision. The alert may include, without limitation, an emergency call to emergency departments, including, without limitation, police, ambulance, fire department, and tow truck. The alert portion may further emit an audible signal to alert to pedestrians and vehicles in proximity that a collision has occurred. The audible signal may include, without limitation, a siren, a beep, a human voice, and a bright flashing illumination from the vehicle. In one embodiment, the alert portion may include a button or pedal in proximity to the vehicle operator that may be depressed at any time to alert emergency responders of a medical problem.

In some embodiments, the identification system may include a communication device that positions inside the vehicle, within reach of the vehicle operator. The communication device may include a telephone, which a vehicle operator may utilize to initiate contacts after the collision. Additionally, the communication device may include a processor that provides additional functions. The communication device may be configured to receive information about the impacting object from the at least one camera. The information may be stored and/or transmitted. The information may include, without limitation, a vehicle identification number, a license plate number, driver's license information for the operator of the impacting object, and a photograph of the impacting object and operator. In some embodiments, the antenna may transmit the information. The antenna may further communicate with a global positioning system for relaying the location of the vehicle after the collision. This positioning function may help emergency vehicles locate the vehicle more efficiently.

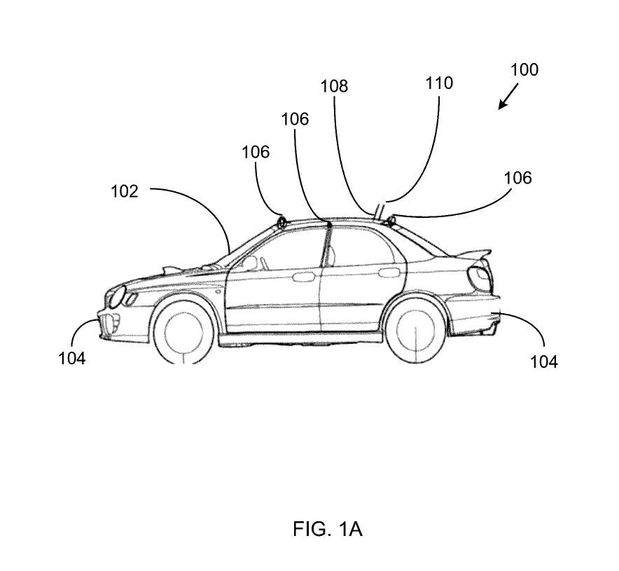

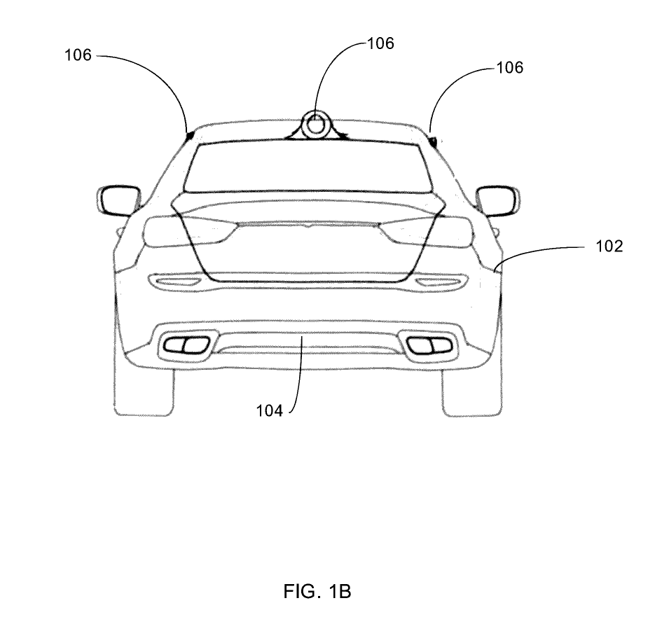

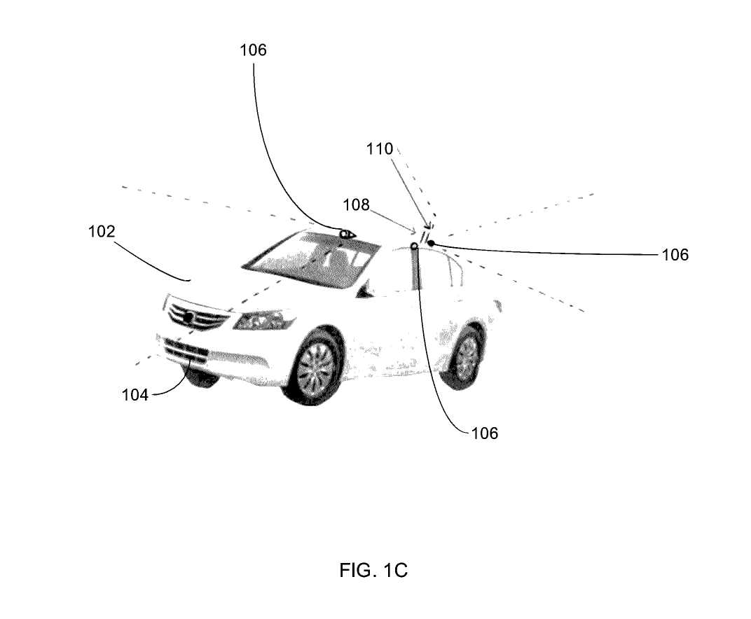

FIGS. 1A, 1B, and 1C illustrate various views of an exemplary vehicle with an exemplary identification system, where FIG. 1A illustrates a side view of an exemplary vehicle, FIG. 1B illustrates a rear view of an exemplary vehicle, and FIG. 1C illustrates a detailed perspective view of an exemplary vehicle, in accordance with an embodiment of the present invention. In the present embodiment, a vehicle identification system 100 may provide a system for identifying at least one vehicle in a collision or accident. In some embodiments, the identification system may join with a vehicle 102 to detect a forceful collision with an impacting object, identify the impacting object, store information about the impacting object, and finally relay the information to a remote location. In one embodiment, the identifying system may be included with the vehicle during manufacture. However, in other embodiment, the identifying system may be sold as a kit and integrated into the vehicle after market. The impacting object may include, without limitation, at least one impacting object that engages the vehicle. In this manner, a collision may be better documented and relayed to a proper authorities automatically. Those skilled in the art, in light of the present teachings, will recognize that during a collision, a vehicle operator may not be able to identify and relay information about a collision. The identification system automatically performs this task.

In one embodiment of the present invention, the identification system may include a plurality of components that create a synergy that helps identify the impacting object immediately during a collision. Each component may perform an interdependent function for identifying and relaying information about the collision and the impacting object. In some embodiments, the identification system may include at least one impact sensor 104 for actuating the identification system. The at least one impact sensor may be disposed to position on a periphery of the vehicle, including, without limitation, a front bumper and a rear bumper. However, the at least one impact sensor may position on the side doors of the vehicle. Those skilled in the art will recognize that the at least one impact sensor may be operable to detect an impact, vibration, and physical deformation on the vehicle from the impacting object. However, in other embodiments, the impact sensor may be configured to sense other physical actions, including, without limitation, Light, motion, temperature, magnetic fields, gravity, humidity, moisture, vibration, pressure, electrical fields, sound, and other physical aspects of the external environment. The at least one impact sensor may be adjusted to detect different amounts of force, whereby a simple bump from a vehicle may not actuate the identification system.

In some embodiments, the identification system may include at least one camera 106 for capturing the image of the impacting object prior to, during, and after a collision. The at least one camera may include a still photo camera, and a video camera. Each camera may position in a strategic location on the vehicle for capturing the desired image. Those skilled in the art, in light of the present teachings, will recognize that traffic collisions most often include, without limitation, head-on, road departure, rear-end, side collisions, and rollovers. The at least one camera should be positioned to capture these anglers of collision. In some embodiments, the at least one camera may be disposed to position on a front section and a rear section of the vehicle, such as on the roof. The front and rear cameras may include two walnut sized cameras that position in proximity to the roof, yet have sufficient viewing angles to capture an image at 180°. In one embodiment, the at least one camera may include a total of four cameras, front, rear, right and left side, with each having a 180° view.

In some embodiments, the at least one camera may further be disposed to position on a left side section and a right side section of the vehicle, in proximity to a vehicle door. The side cameras may include two dime size cameras that position between the front and rear doors. The at least one camera may b operable to provide a 180° view. The at least one camera may position flush against the vehicle, to form a flat surface. In some embodiments, an antenna 110 may be configured to communicate the location of the impact with a positioning system. In some embodiments, the at least one camera may create a flash at the time of taking the image. The flash may be actuated by a second antenna. The image generated by the at least one camera may be recorded through various means, including, without limitation, saved on a SIM card, printed, and transmitted to a remote location. In this manner, the impacting object may be documented more accurately.

In one embodiment of the present invention, the identification system may include an alert portion 108 that operatively joins with the at least one camera and the at least one impact sensor. The alert portion may emit an alert in response to the collision. The alert may include, without limitation, an emergency call to emergency departments, including, without limitation, police, ambulance, fire department, and tow truck. The alert portion may further emit an audible signal to alert to pedestrians and vehicles in proximity that a collision has occurred. The audible signal may include, without limitation, a siren, a beep, and a human voice. In one embodiment, the alert portion may include a button or pedal in proximity to the vehicle operator that may be depressed at any time to alert emergency responders of a medical problem, including, without limitation, a heart attack, an epilepsy, and a fainting spell. The button may be sufficiently sized and dimensioned for easy access, including an area of 2″ by 2″.

In some embodiments, the identification system may include a communication device that positions inside the vehicle, within reach of the vehicle operator. The communication device may include a telephone, which a vehicle operator may utilize to initiate contacts after the collision. However, in other embodiments, the communication device may include, without limitation, a smart phone, a laptop, a tablet, a computer and a GPS system. The communication device may include a processor that provides additional functions. For example, without limitation, the communication device may be configured to receive information about the impacting object from the at least one camera. The information may be stored and/or transmitted. The information may include, without limitation, a vehicle identification number, a license plate number, driver's license information for the operator of the impacting object, and a photograph of the impacting object and operator. In some embodiments, the antenna may transmit the information. The antenna may further communicate with a global positioning system for relaying the location of the vehicle after the collision. This positioning function may help emergency vehicles locate the vehicle more efficiently.

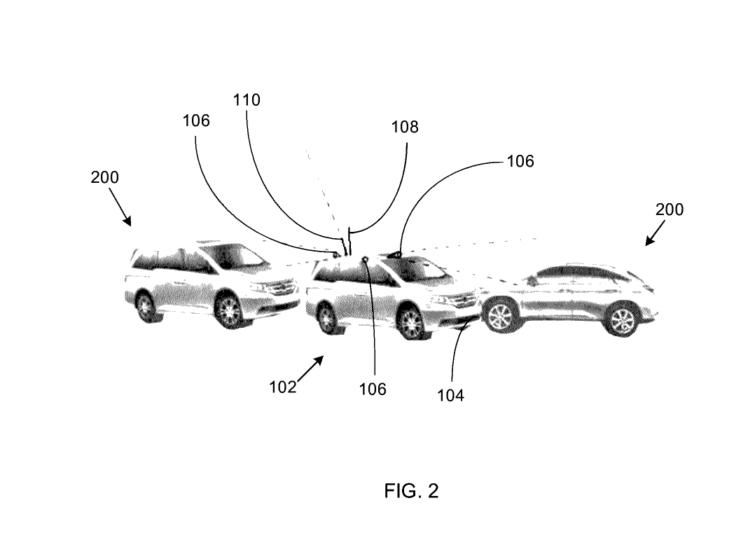

FIG. 2 illustrates a detailed perspective view of an exemplary collision between an exemplary vehicle and an exemplary impacting object, in accordance with an embodiment of the present invention. In the present embodiment, the vehicle may be impacted by an impacting object 200. The impacting object may include, without limitation, another vehicle, a pedestrian, an animal, road debris, or a stationary obstruction, such as a tree or utility pole. In some embodiments, the impacting object may include a plurality of impacting objects that collide into the vehicle. The identification system may be equipped to identify the plurality of impacting objects due to multiple cameras and impact sensors positioned on the periphery of the vehicle.

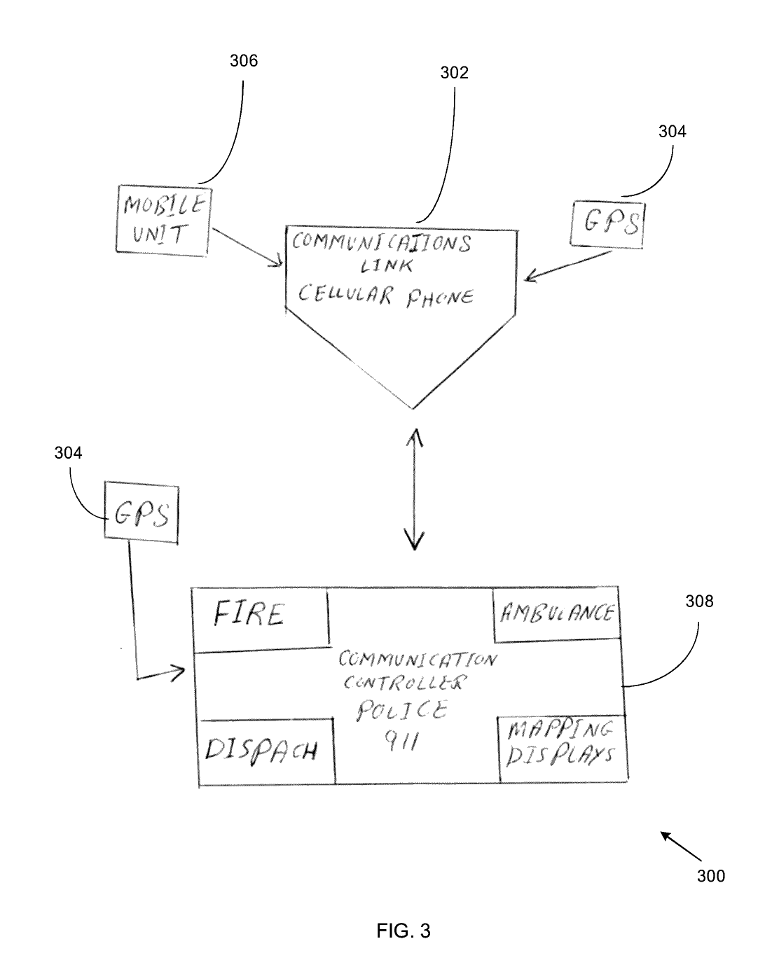

FIG. 3 illustrates a block diagram of an exemplary communication system communicating a collision to a remote location, in accordance with an embodiment of the present invention. In the present embodiment, the identification system may be configured to relay information about the collision to a remote location through a communication system 300. The communication system device performs multiple functions, and works in conjunction with a communication device 302 to identify, record, and relay information about the collision. The communication device may be operatively joined with the antenna and the alert portion to communicate the location of the collision to a remote location 308. The remote location may include, without limitation, an emergency department, a police station, and a positioning system site. The antenna may communicate with a positioning system 304, such as a global positioning system to pinpoint the exact location of the vehicle and the collision. However, in other embodiments, the positioning system may include a cell tower radio frequency may be utilized to telegraph the location of the collision. The remote location may then send an emergency unit 306 to the scene of the collision for appropriate action. The emergency unit may include, without limitation, a police car, an ambulance, a fire truck, and a tow truck. In another embodiment, the communication device may receive information about the impacting object from the at least one camera and relay this information to the remote location for processing. In this manner, the emergency unit may be made aware of the collision circumstances prior to arriving at the scene of the collision. For example, without limitation, a police vehicle may be alerted for a hit-and-run impacting object while arriving at the scene of the collision.

In one alternative embodiment, the at least one camera may relay a video in real time to a remote data storage site. In yet another alternative embodiment, the at least one impact sensor may be operable to sense vandalism on the vehicle, such as a key scratching the vehicle, or a knife puncturing the tires. In yet another alternative embodiment, the alert portion includes a human voice that gives instructions to all parties involved in the collision.

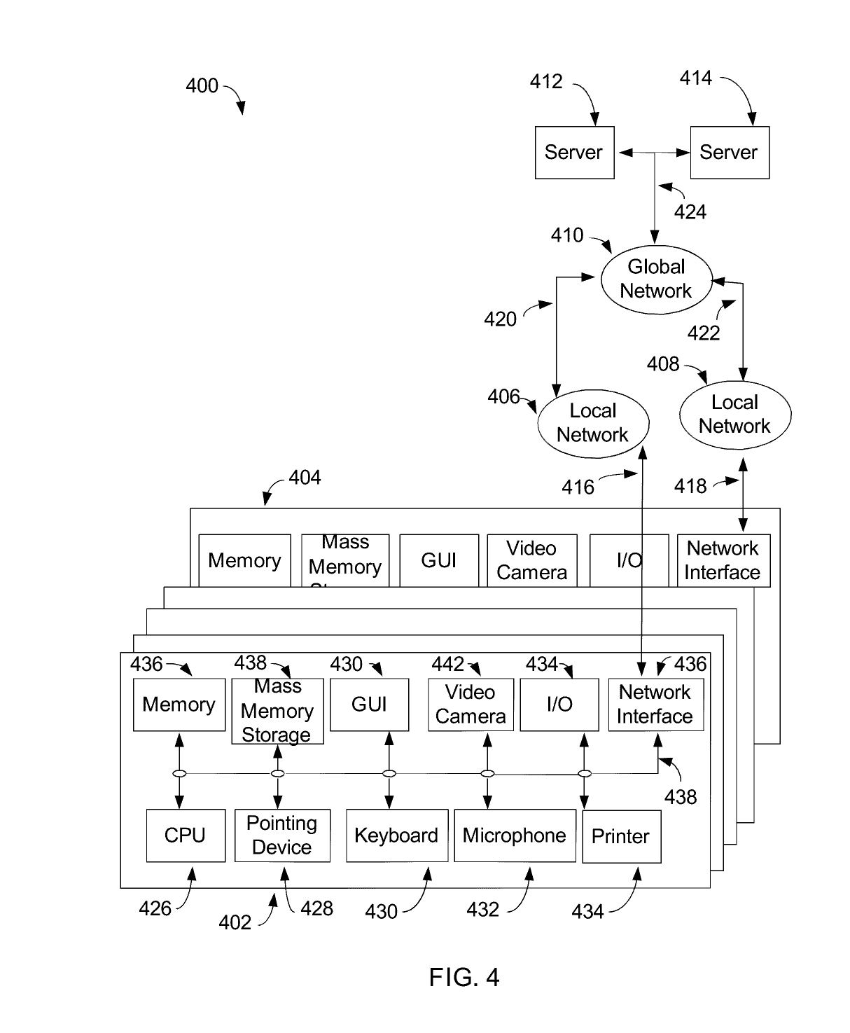

FIG. 4 illustrates a typical computer system that, when appropriately configured or designed, can serve as an exemplary method for detection, in accordance with an embodiment of the present invention. In the present embodiment, a communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate hi-directionally with local network 406 via a communication channel 416. Client 404 may communicate hi-directionally with local network 408 via a communication channel 418. Local network 406 may communicate bi-directionally with global network 410 via a communication channel 420. Local network 408 may communicate hi-directionally with global network 410 via a communication channel 422. Global network 410 may communicate bi-directionally with server 412 and server 414 via a communication channel 424. Server 412 and server 414 may communicate hi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WAN s), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 440, video camera 442, input/output interface 444 and network interface 446 may communicate in a unidirectional manner or a bi-directional manner with each other via a communication channel 448. Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally inplemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features,

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3rd parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a system for identifying vehicles involved in a collision according to the present invention will be apparent to those skilled in the art. Various aspects of the invention have been described above by way of illustration, and the specific embodiments disclosed are not intended to limit the invention to the particular forms disclosed. The particular implementation of the system for identifying vehicles involved in a collision may vary depending upon the particular context or application. By way of example, and not limitation, the system for identifying vehicles involved in a collision described in the foregoing were principally directed to impact sensors, cameras, and communication devices for relaying information about a collision between vehicles implementations; however, similar techniques may instead be applied to collision information between ships, or planes, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

What is claimed is:

1. A method for identifying and recording acts relating to an impact between an impacting object and a parked vehicle, which comprises:
providing at least one impact sensor on a vehicle, with the at least one sensor disposed on a periphery of the vehicle and configured to sense an impact on the vehicle from an impacting object;
providing at least one camera on the vehicle, with the at least one camera disposed on a periphery of the vehicle and configured to pivot over an angle of 180° to record an image of the impacting object immediately after impact, wherein the at least one camera is operatively associated with the at least one impact sensor and is activated only when the at least one impact sensor detects an impact on the vehicle so that the camera(s) can automatically capture image information of the impacting object immediately after impact;
electronically associating the camera(s) with a memory device so that image information of the impacting object captured by the camera is forwarded to and stored on the memory device; and
providing a communication device configured to relay the image information to a remote location;
wherein any impact to the vehicle when parked and unoccupied are sensed with the image information collected and forwarded to the remote location to identify and document what caused damage to the vehicle.

2. The method of claim 1 which further comprises providing an alert portion on the vehicle, with the alert portion operatively associated with said the at least one sensor and at least one camera so that the alert portion emits an alert only when the at least one impact sensor detects an impact on the vehicle.

3. The method of claim 2 wherein the alert portion is configured to emit and relay the alert to an emergency department to provide notice of the impact.

4. The method of claim 3 wherein the alert comprises a siren.

5. The method of claim 1 wherein communication device comprises a telephone.

6. The method of claim 1 which further comprises providing the vehicle with an antenna configured to relay vehicle location to a global positioning system when the at least one impact sensor detects an impact on the vehicle.

7. The method of claim 1 wherein one impact sensor is disposed to position on a front bumper of the vehicle, and another sensor is disposed to position on a rear bumper of the vehicle.

8. The method of claim 1 wherein two walnut sized cameras are provided, one on each longitudinal end of the vehicle.

9. The method of claim 1 wherein the at least one camera is a video camera configured to pivot up to 180 degrees for recording of the image.

10. The method of claim 9 wherein at least one camera is configured to zoom in on the impacting object after impact.

11. The method of claim 9 wherein the at least one camera is configured to print the image of the impacting object.

12. The method of claim 1 wherein the communication device comprises a processor, configured to record and/or store information about the impacting object immediately after impact.

13. The method of claim 1 wherein the communication device comprises a subscriber identity module card for identifying said vehicle and relaying information about said impact and said location to said emergency department.

14. The method of claim 1 wherein the image information about the impact comprises one or more of an impacting vehicle identification number, a license plate number, a driver's license number, a color, or a vehicle model.

15. The method of claim 1 which further comprises providing the vehicle with a second antenna configured to produce a flash for enhancing the image information that is recorded by the at least one camera.

16. A method for identifying and recording acts relating to an impact between an impacting object and a parked vehicle, which comprises:
providing at least two impact sensors on different positions on a vehicle, with the sensors configured to sense an impact on the vehicle from an impacting object;
providing at least two cameras on the vehicle, with each camera disposed on a longitudinal end of the vehicle and configured to pivot over an angle of 180° to record an image of the impacting object immediately after impact, wherein the cameras are operatively associated with the sensors and are activated only when an impact sensor detects an impact on the vehicle so that the cameras can automatically capture image information of the impacting object immediately after impact;
electronically associating the cameras with a memory device so that image information of the impacting object captured by the camera is forwarded to and stored on the memory device;
providing the vehicle with a first antenna configured to relay vehicle location to a global positioning system when the at least one impact sensor detects an impact on the vehicle.
providing a communication device comprising a telephone configured to relay the image information and global positioning information to a remote location;
providing the vehicle with a second antenna configured to produce a flash for enhancing the image information that is recorded by the camera(s); and
providing an alert portion on the vehicle, with the alert portion operatively associated with said the at least one sensor and at least one camera so that the alert portion emits an alert only when the at least one impact sensor detects an impact on the vehicle;
wherein any impact to the vehicle when parked and unoccupied are sensed with the image information collected and forwarded to the remote location to identify and document what caused damage to the vehicle and where the vehicle is located.

17. The method of claim 16 wherein the cameras are video cameras configured to pivot up to 180 degrees for recording of the image and having zoom capability to focus on the impacting object after impact, and wherein the alert portion comprises a siren configured to emit and relay the alert to an emergency department to provide notice of the impact.

18. The method of claim 16 wherein the communication device comprises a processor, configured to record and/or store information about the impacting object immediately after impact, wherein the communication device comprises a subscriber identity module card for identifying said vehicle and relaying information about said impact and said location to said emergency department; and wherein the image information about the impact comprises one or more of an impacting vehicle identification number, a license plate number, a driver's license number, a color, or a vehicle model.
